(19) United States
(12) Patent Application Publication
(10) Pub. No.: US 2014/0375527 A1
(43) Pub. Date: Dec. 25, 2014

(54) Antenna Arrangement

(71) Applicant: ProAnt AB, Umea (SE)

(72) Inventor: Tomas Rutfors, Holmsund (SE)

(73) Assignee: ProAnt AB, Umea (SE)

(21) Appl. No.: 14/249,504

(22) Filed: Apr. 10, 2014

(30) Foreign Application Priority Data
Apr. 29, 2013 (SE) 1300312-4

(51) Int. Cl. H01Q 9/04; H01Q 5/00

(52) U.S. Cl. CPC H01Q 9/045; H01Q 5/0027
USPC 343/906

(57) ABSTRACT

The present invention provides a solution to how an antenna of the Patch or PIFA type can be made from a sheet metal in order for thereafter to be mounted on a printed circuit board with particularly formed mounting areas in order to provide both an inexpensive but yet robust and efficient antenna solution.

### TECHNICAL FIELD

The present invention concerns an antenna arrangement comprising a printed circuit board and an antenna element mounted thereon.

### PRIOR ART AND BACKGROUND OF THE INVENTION

Antennas for incorporation in radio equipment entails a plurality of demands that often are difficult to combine in one product. They should be robust and, at the same time, the one and the same antenna should be able to be used with several different products; they should be mountable in a normal surface mounting process and have a low cost.

The antennas that usually are able to handle demands on robustness the best and can be used with a plurality of different products are antennas that are placed above a ground plane and are often called Patch or PIFA antennas (Planar Inverted F Antenna). These antennas need a point of connection to connect a radio signal to the antenna, however, in most cases two points of connection are used, one for a radio signal and another for the ground plane. These two points of connection are usually placed near to each other to create an antenna with an impedance of 50 Ohms.

There are also antennas that are located outside ground planes, they are called monopole antennas. The monopole interacts in another way with the rest of the product what makes these antennas less robust and they need to be adapted to the product to a higher extent. Most commonly, the performance is also somewhat lower than for Patch and PIFA antennas.

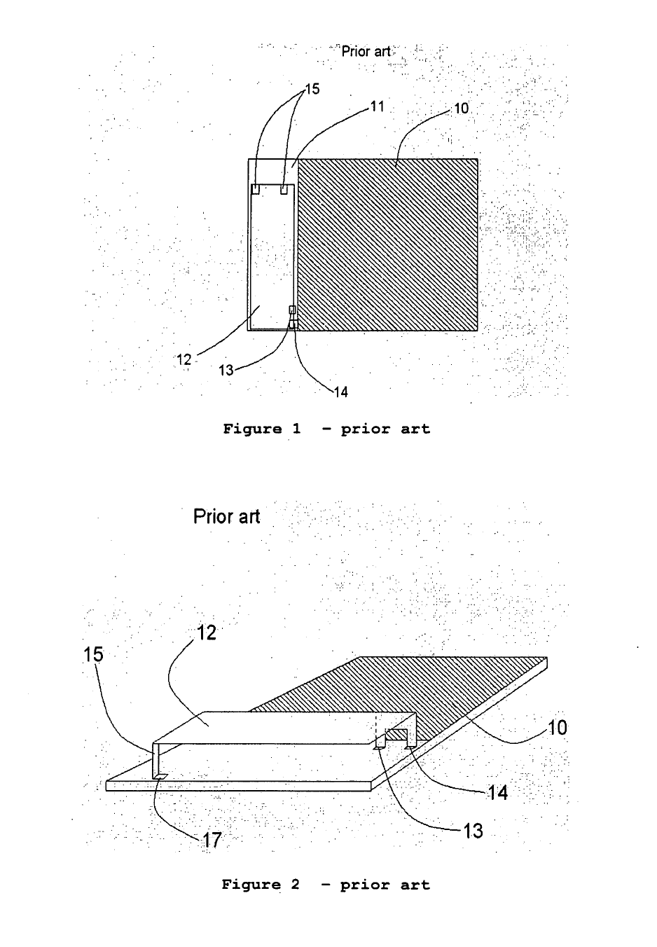

There are monopole antennas that are formed in sheet metal that is punched and bent, where they are placed outside a ground plane according to FIGS. 1 and 2. The antenna element 12 is placed on the surface 11 that lacks electrically conducting material, where pin 13 for a radio signal is connected to the antenna element, that also can have an additional support pin 15. It could also be considered to have ground 10 connected to the antenna element 12 via the pin 14.

With a construction according to FIGS. 1 and 2, the antenna becomes a monopole type antenna and will be less robust than an antenna of the PIFA type, which has a ground plane located under the antenna element.

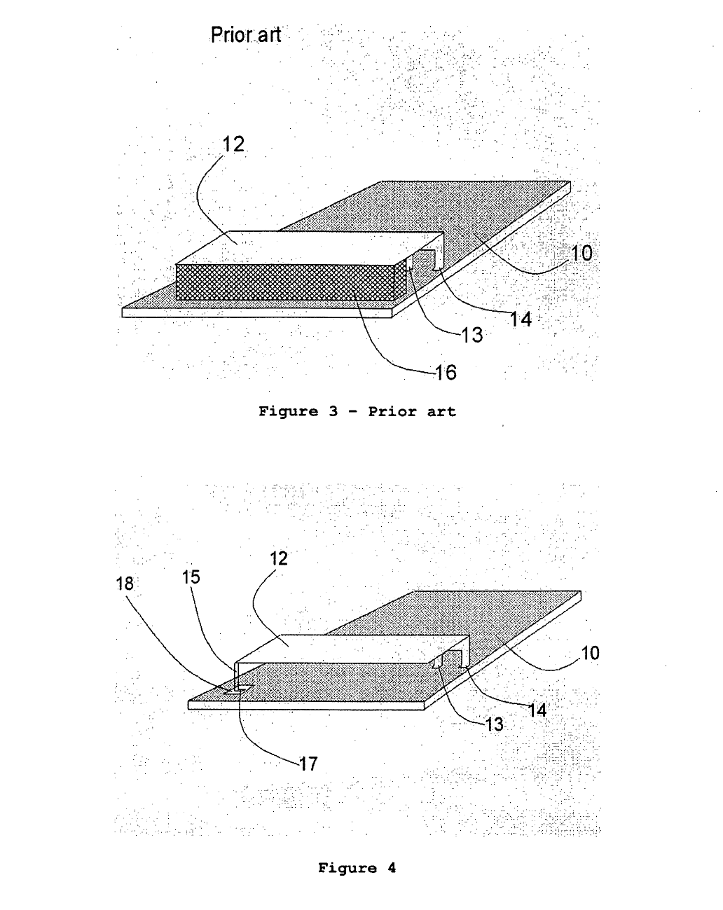

If there is a ground plane below the antenna, the additional support pins 15 can not be used for mechanical support, for such a support then, only the pins for a radio signal and possibly ground, if desired, can be connected, Since these are placed near to each other, the antenna is rendered mechanically unstable. To have a stable antenna, the antenna element, which may comprise a thin, flat, electrically conductive material, usually is placed on a plastic carrier 16 according to FIG. 3. With fiat is meant for instance a sheet metal of suitable thickness to enable forming for instance support pins and any slits as well as to achieve a sufficient mechanical stability.

This entails the drawback that an additional component is added and therefore an additional process step, which makes the antenna more expensive.

There are antennas today that are formed in sheet metal for surface mounting. They are of the monopole type and are mounted outside the ground plane.

These antennas are often not able to handle the demands on robustness since their resonance frequency most commonly change markedly when the same antenna is mounted in different products.

Additionally, it is desirable to have a ground plane that is as large as possible to efficiently use the available area of the printed circuit board for electronics components. If the antenna can have a ground plane below itself, electronics components can be placed on the opposite side and also on the same side but below the antenna element.

### SUMMARY OF THE INVENTION

It is an object of the present invention to propose a solution or a reduction of the problems with the prior art.

Thus, a main object is to solve the problem with how an antenna arrangement with an antenna element can be produced with a stable mechanical construction that is not unstable and can turn over, and which still provides an antenna arrangement with good performance even when the antenna arrangement is achieved by the mounting of the antenna element on a plurality of different products, such that a production of punching tools specific for a product is avoided.

The present invention solves the above problem with a device according to claim 1,

In this way, an antenna arrangement is provided with an antenna element and an underlying printed circuit board with a ground plane, combined with the fact that the support pins of the antenna element can be placed at a distance from each other that allows for a stiff mechanical connection between the antenna element and the printed circuit board.

The combination of the antenna element with an underlying ground plane provides the antenna arrangement with stable radio properties, such as with Patch or PIFA antennas,

Further, a support pin can be placed at an optional location under the antenna element for mechanical stability, since the solution with an isolation distance between the contact surface of the support pin on the printed circuit board and other metal on the printed circuit board lessens the impact from this pin on the radio properties of the antenna arrangement.

In this way, an antenna arrangement is provided with the advantages of stable/robust radio properties corresponding to a PIFA or a Patch antenna combined with a construction that is mechanically stable without the need of a plastic carrier, that is traditionally associated with such PIFA or Patch antennas.

Thus, such a plastic carrier can be avoided at the same time as the contact surface(s) with an isolation distance to other metal on the printed circuit board does not create any extra costs. All in all, the present invention consequently provides a cheaper product with performance similar to PIFA/Patch antennas.

### DESCRIPTION OF FIGURES

1: Prior art with antenna outside ground plane, view from above

2: Prior art with antenna outside ground plane, view side-faced

3: Prior art with antenna above ground plane with isolation component

4: Technology according to the present invention with extra support pin with solder to surface on printed circuit board which has an isolation distance to metal, view side-faced

5: Technology according to the present invention with image of an alternative embodiment of the printed circuit board.

6: Technology according to the present invention with alternative embodiment of the antenna element with slit

7: Technology according to the present invention with embodiment where an antenna element protrudes partly outside the printed circuit board.

### PREFERRED EMBODIMENTS

In order to create a robust antenna element that can be mounted on a printed circuit board, the antenna element shall be placed at a distance above the ground plane of the printed circuit board.

In order to be mechanically stable, at least two but In practice three or more pins to mount the antenna element with are needed.

In order to achieve an inexpensive product, it is most suitable that the antenna element and connection pins are formed in one and the same component, which most suitably is a piece of flat, electrically conductive material, which is solderable in a normal surface mounting process.

The process that in most cases is the least expensive to create a suitable design is to punch and bend a thin piece of sheet metal. The design is determined from the demands on resonance frequency, bandwidth and efficiency that the wireless system imposes.

An antenna element of the PIFA type shall also be placed at a suitable height above the ground plane to have good radiating properties. This can easily be created in the punching and bending process with bent pins that also have feet of appropriate size and design for the surface mounting process.

Thereafter the antenna element may be placed in Tape and Reel, which is the name of a desired packaging for surface mounting machinery.

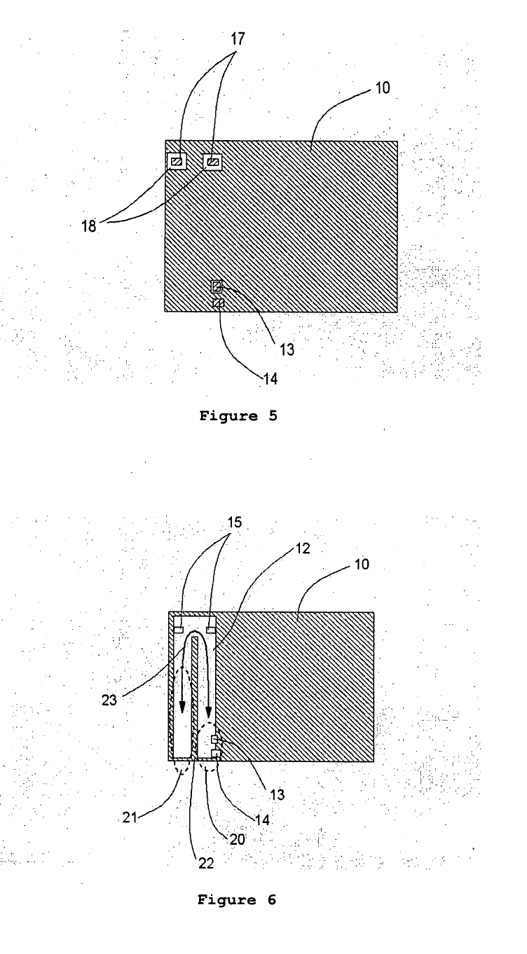

FIG. 4 discloses an example of an antenna according to the present invention comprising a printed circuit board with an electrically conducting area 10, an antenna element 12 with at least two but usually more pins 15 which are bent for the main area of the antenna element to be located at a distance from the ground plane.

A radio signal is connected to the antenna element at a pin 13. The support pin 15 of the antenna element is connected to contact surfaces 17 on the printed circuit board, which contact surfaces 17 have an isolation distance 18 to the ground plane of the printed circuit board or other metallic material 12. Often, ground is also connected to the antenna element via an additional terminal 14. This connection is not always necessary, but can be replaced by components mounted on the printed circuit board.

The printed circuit board can be formed in accordance with FIG. 5, where the surfaces 17 have an isolation distance 18 to the surrounding metallic material.

The isolation distance can advantageously also be used in an adjustment method for the adjustment of the properties of the antenna. In such an adjustment method of an antenna arrangement according to the invention the isolation distance is varied while the properties of the antenna arrangement are measured until such an isolation distance has been attained, by which the desired radio properties are attained. For instance, the isolation distance can be lessened, relative an earlier distance, to have the resonance frequency of the antenna lessened and by that, the antenna element can be smaller than it would have been without the extra support pins and its isolation distance. This provides a very good opportunity to provide the antenna with a smaller area, which often is attractive since many applications have a shortage of free space for the antenna. This property can also be used to increase the possibility to use the same punched sheet metal for a plurality of products. The isolation distance also provides possibilities to connect electrical components between the pins of the antenna element and the metal of the printed circuit board. By way of a capacitance between the pin(s) of the antenna element arid the metal of the printed circuit board, the resonance frequency of the antenna will be reduced and depending on the magnitude of the capacitance the resonance frequency of the antenna arrangement will be reduced to different extents. This provides the possibility to reduce the sire of the antenna element for a given resonance frequency. Also, more sophisticated arrangements are possible with different filtering properties.

The part of the antenna which is in electrical contact with a point of connection for a radio signal is called an excitation portion or the beginning of the antenna which is depicted by the area 20 in FIG. 6.

This part has the lowest electrical field intensity and therefore is the least sensitive for surrounding metallic and dielectric material.

The radio signal creates currents 23 along the extension of the electrically conductive material 23 of the antenna and at the top of the antenna the electrically conductive material ends and there the electrical field is the strongest, which is shown as area 21 in FIG. 6. For this reason, it is most suitable to locate support pins within other areas in order not to impair the performance of the antenna. The more far out on the antenna that support pins 15 are located, the larger the isolation distance 18 needs to be in order to not impair the performance of the antenna.

In order to have both a mechanical stability with a large physical distance between the pins of the antenna but still locate support pins electrically close to the excitation point of the antenna, it is suitable to form a slit 22 in the antenna element 12 in such a way that the slit enters the antenna element close to the point of excitation of the antenna, see FIG. 6.

Besides keeping a good performance, the slit also provides a good opportunity to reduce the area of the antenna for a specified resonance frequency and also provide an antenna with dual band operation since the slit can create an extra resonance frequency which is suitable for both GSM and WLAN applications.

It is also desirable that the antenna should have as confined a size as possible. Therefore, it is preferred that surfaces for mounting of the antenna are located under the antenna. It is possible by bending the pins of the antenna such that a foot is created under the antenna. In this way the antenna does not have to occupy more space than that of its active area.

Generally, the antenna according to the invention has an underlying ground plane. it is however, realised by the skilled person that parts of large parts of the ground plane under the antenna can be removed as long as one of the support pins is surrounded by electrically conducting material on the printed circuit board, which creates the necessary function according to the invention.

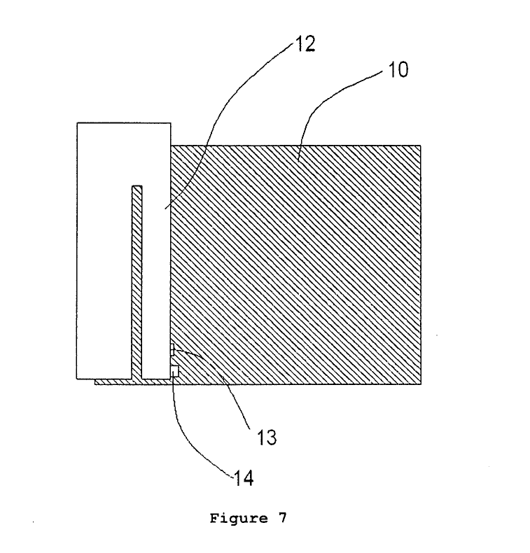

As a clarification, it can be mentioned that with the above described construction, there is nothing that prevents the antenna element from, at least partly, protrude outside of the printed circuit board, for instance in the way that is shown in the embodiment of FIG. 7, with retained function for the antenna arrangement according to the invention. (The reference numerals that are used in FIG. 7 correspond to those already used, see for instance FIG. 6.)

1. Antenna arrangement, comprising:
a printed circuit board,
an antenna element (12), formed in a flat, electrically conductive material, which antenna element comprises at least two pins, each of which is in electrical contact with each of a contact surface of the printed circuit board by way of solder points, wherein at least one of said pins is in electrical contact with a point of connection for a radio signal (13), wherein at least one said contact surface (17) on the printed circuit board for at least one said pin has an isolation distance (18) to other metal on the printed circuit board (10) and is surrounded by a ground plane.

2. Antenna arrangement according to claim 1, wherein the antenna element (12) comprises a slit (22) that extends from one outer edge of the antenna element and into said antenna element, where the pin of the antenna element that is in electrical contact with the point of connection for a radio signal (13) is located in an area by an edge of the antenna element at the slit.

3. Antenna arrangement according to claim 1, wherein the pins (15) are located along the outer contour of the antenna element and are bent in under a main plane of the antenna element (12), wherein the contact surfaces of the printed circuit board (17) are located inside an orthogonal projection of the outer contour of the antenna element on the printed circuit board.

4. Antenna arrangement according to claim 1, wherein the printed circuit board has said ground plane (10) located under the antenna element (12).

5. Antenna arrangement according to claim 2, wherein the pins (15) are located along the outer contour of the antenna element and are bent in under a main plane of the antenna element (12), wherein the contact surfaces of the printed circuit board (17) are located inside an orthogonal projection of the outer contour of the antenna element on the printed circuit board.

6. Antenna arrangement according to claim 2, wherein the printed circuit board has said ground plane (10) located under the antenna element (12).

7. Antenna arrangement according to claim 3, wherein the printed circuit board has said ground plane (10) located under the antenna element (12).

8. Antenna arrangement according to claim 5, wherein the printed circuit board has said ground plane (10) located under the antenna element (12).
